(19) United States
(12) Patent Application Publication
(10) Pub. No.: US 2011/0167652 A1
(43) Pub. Date: Jul. 14, 2011

(54) Handsaw with annular saw blade and saw blade drive

(76) Inventor: Bernhard Brehm, Calw-Stammheim (DE)

(21) Appl. No.: 12/930,634

(22) Filed: Jan. 12, 2011

(30) Foreign Application Priority Data
Jan. 13, 2010 (DE) 10 2010 004 604.3

(51) Int. Cl. B27B 5/14

(52) U.S. Cl. 30/389

(57) ABSTRACT

The ring-shaped saw blade and an associated saw blade drive are provided as an easy exchangeable tool preset for a hand guided saw. The saw is distinguished by high stability, low weight proper, high flexibility as well as high precision and is suitable for an easily to handle and quick connection with a high speed compact and a hand guided electrical drive unit. The ring-shaped saw blade exhibits circular disposed flank toothing on two sides, wherein the flank toothing runs in a radial direction on two sides. The saw blade with the two cited flank toothings engage into a front side groove of an eccentrically disposed friction wheel, wherein the groove faces of the friction wheel in each case are equipped with the flank toothing which engages into the flank toothings of the saw blade. The saw blade drive comprises a drive wheel on a drive shaft, a drive pinion and a friction wheel on a gear shaft, which is disposed parallel to the drive shaft. The rotary motion of the drive machine was transferred with the drive wheel on the drive shaft onto the drive pinion and the friction wheel on the gear shaft and the friction wheel on the gear shaft and from the friction wheel onto the saw blade.

The invention relates to a saw guided by hand with an annular saw blade and a saw blade drive, which saw blade drive is driven through a friction wheel and a drive pinion on a gear shaft by a drive wheel engaging into the drive pinion on a drive shaft disposed in parallel and by a high speed electrical motor to be coupled to the drive shaft.

A ring-shaped blade of a circular saw and a ring saw with saw blade drive is known from the German printed patent document DE 690 03 593 T2, wherein the ring-shaped saw blade is equipped with at least one ring-shaped drive face made of a flexible, polymeric, solid material and wherein a rotating drive member can be pressed against the ring-shaped drive face in order to effect the rotation of the saw blade around its rotation center. Here the flexible polymeric solid material forms an inner edge part of the saw blade or at least one layer on a side of the web section of the saw ring, or the layer at least on one side of an inner edge part of the saw ring. Furthermore the document teaches a circular ring saw, which comprises rotating drive members, which are furnished with projections, which can be pressed into the flexible material of the saw blade, wherein the projections are furnished in a circumferential groove of a drive disk, and wherein the edge part of the inner circumference of the saw ring, which comprises the flexible material, can be received in the groove. According to a second variation, a drive wheel is furnished with projections, which projections can be pressed into a layer of the flexible material in the web section region of the saw blade. This form of the transfer of the rotary motion from a hydraulic motor onto the ring saw blade of a circular ring saw is problematical, since the inner edge part of the saw ring consists of rubber. This inner edge part is disposed by vulcanization at the inner circumference of the saw ring made of steel. The edge part made of rubber snaps into the circumferential groove of the drive wheel, into which drive wheel the projections are brought in. In this manner, the rubber is pressed wave shaped around the projections into the groove and is to transfer the rotating motion of the motor onto the ring saw blade through this route. The rubber is subject to a very high wear, and the saw rings have to be frequently exchanged for this reason.

The functioning of these transmission variations is very doubtful when high speed motors are employed, but at least cost intensive for the production as well as the maintenance and repair. Also the groove disposed in the one flank of the saw ring, which is furnished for snapping of guide rollers, does not represent a large support for the otherwise expensive drive system.

A drive wheel for the eccentric drive of the saw blade is known from the international printed patent document WO 98/58 757. The drive wheel comprises a carrier part which is seated immediately on the drive axis. A drive ring with a groove on the circumferential side is disposed on an inner collar of the carrier part, wherein the inner edge of the ring saw blade engages the carrier part. The carrier part with the drive ring is directly connected to the drive axle of the motor through an accessory plate and through further conventional connection parts. A circular groove is disposed in a flank of the saw ring, wherein two guide rollers engage in the circular groove and the rollers subjected to spring tension together with the counter holding support rollers press the ring saw blade against the drive wheel. The support of the guide rollers in a groove of the saw ring has to assure the total radial press-on pressure of the saw ring into the drive wheel, which leads to a quick wear of the groove and of the roller rings. Thereafter, the rollers have to be frequently exchanged. The drive wheel placed under protection is expensive based on its many parts during mounting and in a required exchange of the same.

Therefore, it was an object to find a ring-shaped saw blade and a therewith associated saw blade drive as an easily exchangeable tool preset for a saw guided by hand, wherein the saw guided by hand is characterized by high stability, low weight proper, high flexibility as well as high precision and is suitable for an easy to handle and quick connection with the high speed compact and hand guided electrical drive unit.

This object is resolved by a ring-shaped saw blade and an associated saw blade drive with the features of claim 1.

It is to be emphasized that the annular saw blade according to be present invention and the saw ring drive at characterized by a ring-shaped saw blade, wherein on two sides of the inner circumferential face there is exhibited a circular shaped disposed flank toothing, which runs on two sides in a radial direction from an inner front face to an outer front face and wherein the ring-shaped saw blade with its two side flank toothing engages into a front side groove of an eccentrically disposed friction wheel, wherein the oppositely disposed groove faces of the friction wheel are also furnished with a flank toothing in each case, which engage in the flank toothings of the ring-shaped saw blade and wherein the saw blade drive exhibits a drive wheel on a drive shaft, a drive pinion, and exhibits a friction wheel on a gear shaft disposed parallel to the drive shaft, and wherein the rotary motion of the drive machine is to be transferred through the drive wheel of the drive shaft onto the drive pinion and the friction wheel on the gear shaft as well as from the friction wheel to the ring-shaped saw blade. The construction of the ring-shaped saw blade and of the saw blade drive pressure assures a stable force transmission over the flank toothings engaging into each other of the transmission parts. Based on the gear drive intermediate disposed between the drive shaft and the drive wheel and the friction wheel on the gear shaft and its translation, the ring-shaped saw blade and the friction wheel are substantially unloaded with respect to the required radial press-on pressure of the ring-shaped saw blade against the friction wheel.

It is particularly advantageous that the high stability of the flank toothings engaging into each other of the ring-shaped saw blade and of the friction wheel, according to claim 2, is accomplished by the formation of recesses in the inner circumferential faces on two sides and in the inner faces of the front side groove of the friction wheel. The stable force transmission from the friction wheel to the ring-shaped saw blade is in addition supported by the constructively clear formation of the friction wheel according to claim 3, which formation is assured by the force matching and disengageable connection of two disks, wherein the two disks form a groove at their outer circumference, wherein flank toothings a form in the oppositely disposed longitudinal sides of the groove, wherein the flank toothings form a counter toothing to the flank toothing of the ring-shaped saw blade, wherein the friction wheel supported on the gear shaft is guided, according to claim 8, between the inner front face of the ring-shaped saw blade (1) and a recess in the outer circumference of a guide sheet metal.

The guide rollers, according to claim 4, according to the present invention have to be emphasized, wherein the guide rollers exhibit at least three ring-shaped noses at their circumferential faces, wherein the noses engage into the at least three grooves disposed on one side of the internal circumferential face of the ring-shaped saw blade. The support rollers disposed oppositely to the guide rollers and having at least three grooves and four pressure faces, are laid down with the pressure faces at the planar side of the internal circumferential face of the ring-shaped saw blade and the support rollers stabilize in this way the guiding of the ring-shaped saw blade.

The constructive formation of the guide rollers and the support rollers, according to FIG. 9 and FIG. 10, contributes to a further stabilization of the guiding of the ring-shaped saw blade as well as to a lighter weight proper. This stability is obtained by cylindrical hollow bodies, wherein the hollow bodies are open at one front side and exhibit at the oppositely disposed front side a formed-on broken out rest face and with a centered bearing bore hole. The parts by themselves are light weight, but stable. In addition thereto they can receive a tensioning mechanism, which tensioning mechanism is supported in each case disposed opposite to the housing disposed on the front side around the ring-shaped saw blade and the radial press-on pressure of the ring-shaped saw blade can be regulated against the friction wheel with the tensioning mechanism.

A further advantage according to the claims 5 through 7 comprises that the flank toothings of the ring-shaped saw blade and of the friction wheel can be performed as an involute toothing or as a round toothing, wherein the teeth of the flank toothings formed on two sides in the inner circumferential face of the ring-shaped saw blade and the teeth of the flank toothings formed into the oppositely disposed inner faces of the friction wheel can be disposed at equal distances or staggered. This leads to a higher flexibility and stability of the saw blade drive.

The invention is described in more detail in the following by way of two embodiment examples. The drawings show here in

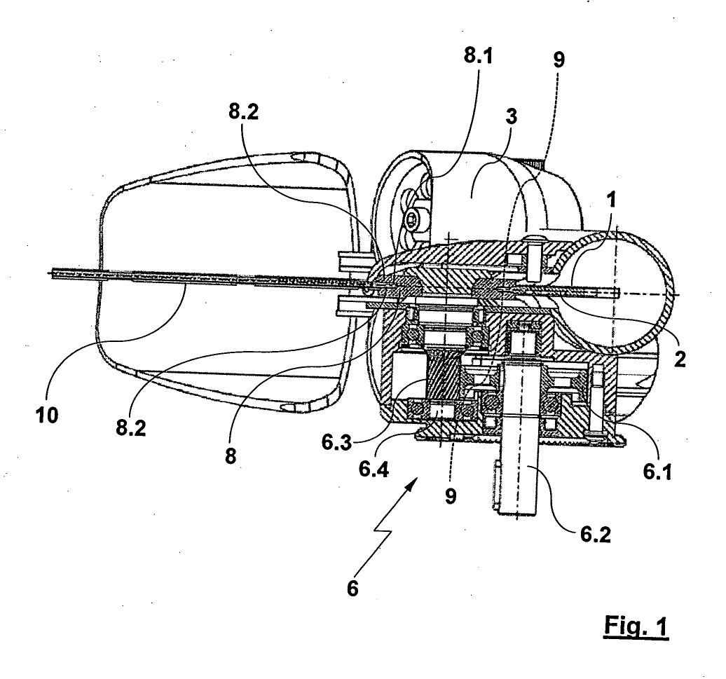

FIG. 1 a top planar view onto a sectional representation through the saw blade drive,

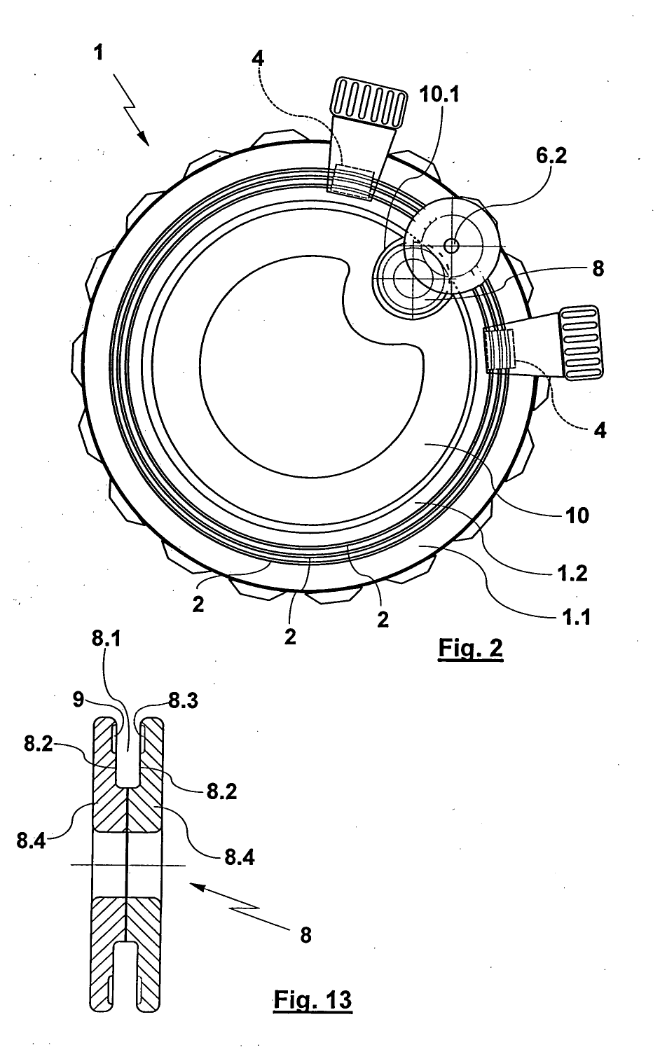

FIG. 2 a side view onto the ring-shaped saw blade, the arrangement of the friction wheel parallel to the drive axis as well as the engagement of the guide rollers into the grooves of the ring-shaped saw blade without toothing engagement,

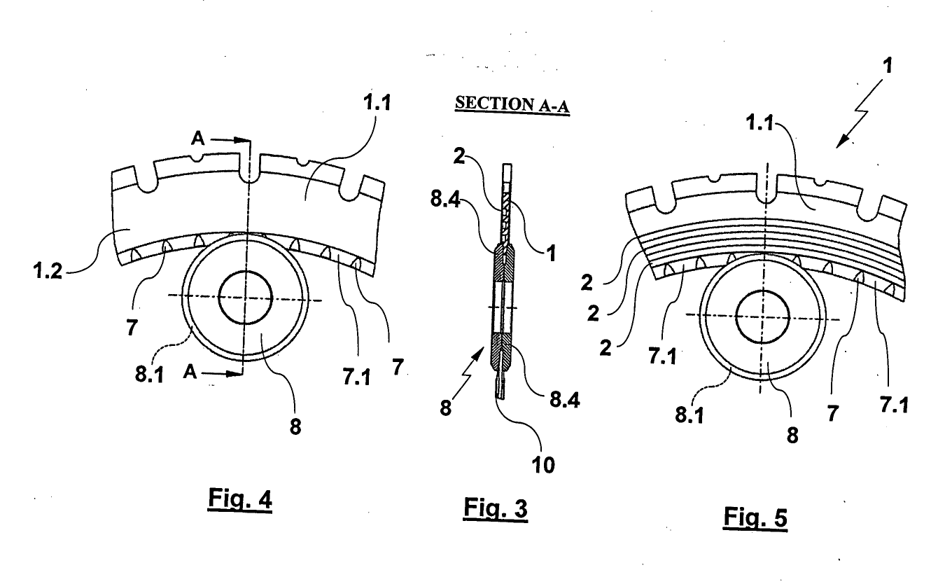

FIG. 3 a sectional representation A-A through the friction wheel, the engaging ring-shaped saw blade with an involute toothing with the same tooth distance on opposite positions and through the guide sheet metal,

FIG. 4 a front elevational view of the section of a side of the ring-shaped saw blade with an involute toothing as well as the position of the ring-shaped saw blade in the circumferential groove of the friction wheel,

FIG. 5 a front elevational view of the section of the oppositely disposed side of the ring-shaped saw blade with an involute toothing and the same tooth distance to the oppositely disposed side as well as grooves for receiving the guide rollers and the position of the ring-shaped saw blade in the circumferential groove of the friction wheel,

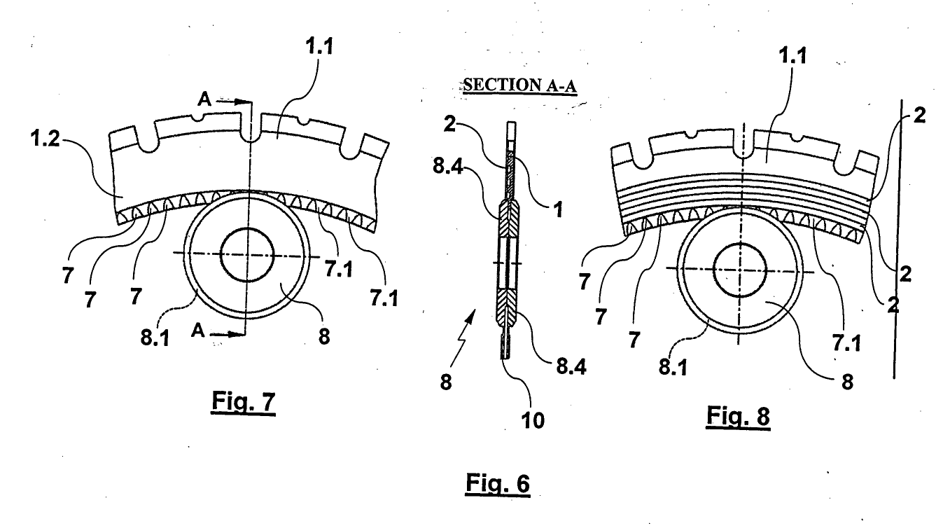

FIG. 6 a sectional representation A-A through the friction wheel, the engaging ring-shaped saw blade with an involute toothing and with staggered tooth distance oppositely disposed and the position of the ring-shaped saw blade in the circumferential groove of the friction wheel,

FIG. 7 a front elevational view of the section of one side of the ring-shaped saw blade with an involute toothing with oppositely staggered tooth distance and the position of the ring-shaped saw blade in the circumferential groove of the friction wheel,

FIG. 8 a front elevational view of the section of the oppositely disposed side of the ring-shaped saw blade with an involute toothing and with a staggered tooth distance to the oppositely disposed side as well as grooves for the guide rollers and the position of the ring-shaped saw blade in the circumferential groove of the friction wheel,

FIG. 9 a perspective view of the support rollers,

FIG. 10 a perspective view of a guide roller,

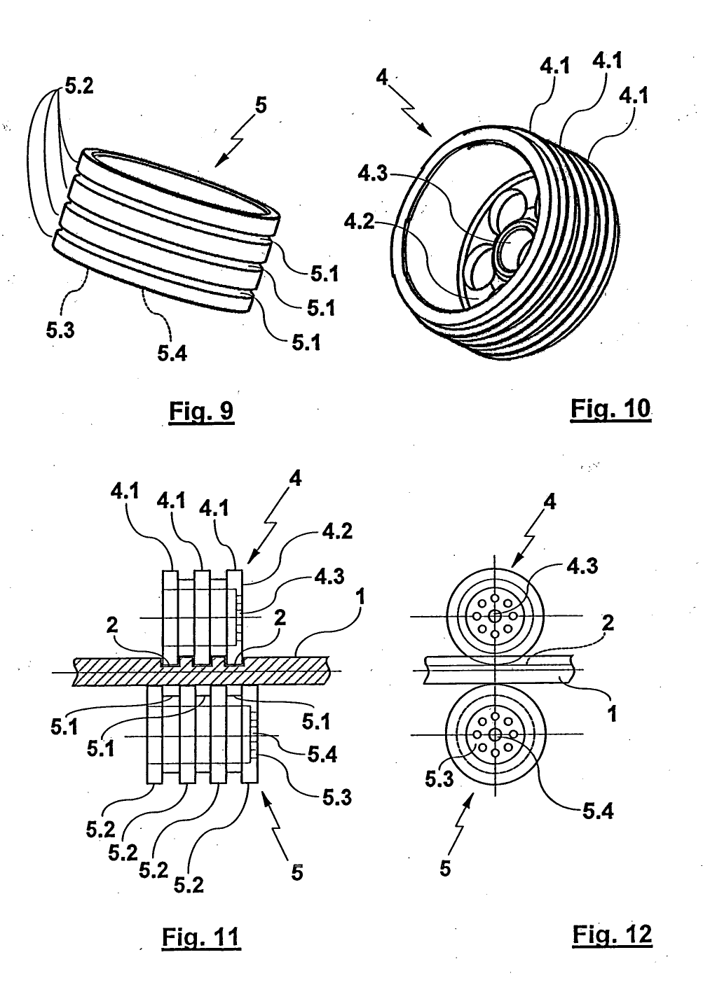

FIG. 11 a front elevational view onto the position of a guide roller in the grooves of the sectioned ring-shaped saw blade and a support holder on the oppositely disposed side in rotary direction,

FIG. 12 a side elevational view onto the ring-shaped saw blade with engaging guide roller and counter holding support roller in radial direction,

FIG. 13 a sectional representation of the friction wheel, wherein the same parts are designated with the same numerals.

FIG. 1 shows a top planar view onto a sectional representation through a saw blade drive 6 according to the present invention for a saw guided by hand with a ring-shaped saw blade 1 and a saw blade drive 6, wherein the saw blade drive 6 is to be driven through a friction wheel 8 and a drive pinion 6.3 on a gear shaft 6.4 by a drive wheel 6.1 disposed on a parallel located drive shaft 6.2, wherein the drive shaft 6.2 is to be driven by a high speed electric motor to be coupled to the drive shaft 6.1 (translator's remark: should be 6.2). The ring-shaped saw blade 1 according to the present invention and according to FIG. 2 is furnished on its inner circumferential face 1.2 on two sides with a flank toothing 7, preferably with an involute toothing, wherein the teeth not illustrated in more detail in the drawing, are arranged oppositely disposed for example in a staggered distance relative to each other, as is illustrated in more detail in FIG. 4 and FIG. 5. The flank toothing 7 is preferably produced by entering of recesses 7.1 on two sides into the inner circumferential face 1.2 of the ring-shaped saw blade 1. The saw blade 1 according to the present invention exhibits on one side of its inner circumferential face 1.2, preferably, three circular shaped grooves 2, wherein preferably two guide rollers 4 at a distance engage in rotary direction the three circular shaped grooves 2. A ring-shaped guide sheet metal 10 with a recess 10.1 is disposed in the center of the ring-shaped saw blade 1. The friction wheel 8 is disposed in the recess 10.1, wherein the friction wheel 8 is supported on the gear shaft 6.4. The friction wheel 8 receives its drive over the drive pinion 6.3 on the drive wheel 6.1 supported parallel to the drive axis 6.4, wherein the drive wheel 6.1 is supported on the drive axis 2. The ring-shaped saw blade 1 receives its drive not directly from the drive wheel 6.1. The rotary motion of the high speed electro drive to be coupled to the drive axis 6.2 and, not illustrated in detail in the drawings, is transformed into force by an intermediate connected gear with a corresponding gear ratio, wherein the force is to be transferred to the friction wheel 8. The rotary motion is transferred from the friction wheel 8 according to the present invention and illustrated in FIG. 13 to the ring-shaped saw blade 1, wherein the friction wheel 8 comprises two disks 8.2, wherein the two disks 8.2 are force matching but disengageably connected to each other and wherein a groove 8.1 is formed at the outer circumferential face of the friction wheel 8. For these purposes the two oppositely disposed longitudinal sides 8.2 of the circumferential groove 8.1 are furnished with a flank toothing 9, preferably with an involute toothing, wherein the teeth of the involute toothing are disposed situated opposite at the same distance relative to each other as the flank toothing 7 on the two sides of the inner circumferential face 1.2 of the ring-shaped saw blade 1. The ring-shaped saw blade 1 snaps with its flank toothing 7 into the groove 8.1 and its flank toothing 9 of the friction wheel 8, whereby the rotary motion can be transferred from the friction wheel 8 to the ring-shaped saw blade 1. With the aid of the guide rollers 4, which penetrate into the preferably three grooves 2 of the ring-shaped saw blade 1, and the counter held support rollers 5, the ring-shaped saw blade 1 can in addition very stable be held and guided in the rotary direction. This stability is achieved in particular by the constructive form of the guide rollers 4 and the support rollers 5, according to FIG. 9 and FIG. 10. The guide rollers 4 and the support rollers 5 are comparatively light weight cylindrical hollow bodies, which are open at one side and exhibit a broken out rest face 4.2 and 5.3 with a central bearing bore hole 4.3 and 5.4 at the oppositely disposed front side. The guide rollers 4 are preferably equipped with three ring-shaped noses 4.1 at their circumferential faces, wherein the noses 4.1 engage into the at least three grooves 2 of the saw blade 1. The support rollers 5 in contrast exhibit at their circumferential faces at least three grooves 5.1 and four pressure faces 5.2, which are resting with the pressure faces 5.2 at the planar side of the inner circumferential face 1.2 of the ring-shaped saw blade 1 and press against the guide rollers 4. The arrangement of the guide rollers 4 and of the support rollers 5 is shown in more detail in FIG. 11 and FIG. 12. Tensioning systems, not shown in detail in the drawings, are laid in the guide rollers 4 and in support rollers 5 based on their shape as hollow cylinders, wherein the radial press-on pressure of the ring-shaped saw blade 1 against the friction wheel 8 can additionally be controlled by hand from the outside with the aid of the tensioning systems.

According to a second embodiment example shown in FIG. 7 and FIG. 8, the teeth of the flank toothing 7 at the ring-shaped saw blade 1 and of the flank toothing 9 at the oppositely disposed faces 8.2 of the groove 8.1 of the friction wheel 8 are disposed opposite laying at equal distances.

### LIST OF REFERENCE CHARACTERS

1. Ring-shaped saw blade,

1.1 Outer circumferential face of the saw blade,

1.2 Inner circumferential face of the saw blade,

2. Grooves in the saw blade,

3. Housing for the saw blade drive,

4. Support rollers (translator's remark: should be Guide rollers),

4.1 Ring-shaped noses,

4.2 Broken out rest faces,

4.3 Bearing bore hole,

5. Support rollers,

5.1 Ring-shaped grooves,

5.2 Ring-shaped press faces,

5.3 Broken out rest faces,

5.4 Bearing bore hole,

6. Saw blade drive,

6.1 Drive wheel,

6.2 Drive shaft,

6.3 Drive pinion,

6.4 Gear shaft,

7. Flank toothing at the saw blade,

7.1 Recesses of the flank toothing,

8. Friction wheel,

8.1 Circumferential groove,

8.2 Oppositely disposed faces of the circumferential groove,

8.3 Recesses of friction wheel,

8.4 Disks of the friction wheel,

9. Flank toothing,

10. Ring-shaped guide sheet metal,

10.1 Recess

1. Handsaw with ring-shaped saw blade and a saw blade drive, wherein a ring-shaped saw blade (1) exhibits an outer circumferential face (1.1) with front side disposed cutting members and an inner circumferential face (1.2) with at least three formed-in circular shaped grooves (2) on one side, one housing (3) disposed around the ring-shaped saw blade (1), on the one hand guide rollers (4) at a distance from the ring-shaped saw blade (1), wherein the guide rollers (4) engage in the circular shape grooves (2) and support rollers (5) at a distance are disposed oppositely in the same plane, that the support rollers (5) additionally guide and support the ring-shaped saw blade (1) and wherein a saw blade drive (6) transfers the rotary motion of a drive machine to the ring-shaped saw blade (1)
characterized in that
the ring-shaped saw blade (1) exhibits a circular arranged flank toothing (7) on the two sides of the inner circumferential face (1.2), wherein the flank toothing (7) runs on two sides in the radial direction from an inner front face (1.3) to an outer front face (1.4),
wherein the ring-shaped saw blade (1) with its flank toothing (7) on two sides engages into a front side groove (8.1) of an eccentrically disposed friction wheel (8), wherein the oppositely disposed groove faces (8.2) in each case are equipped with a flank toothing (9), which engage in the intermediate spaces of the flank toothings (7) of the ring-shaped saw blade (1), and
wherein the saw blade drive (6) exhibits a drive wheel (6.1) on a drive shaft (6.2), a drive pinion (6.3) and a friction wheel (8) on a gear shaft (6.4) disposed parallel to
the drive shaft (6.2) and wherein the rotary motion of the drive machine is to be transferred through the drive wheel (6.1) of the drive shaft (6.2) onto the drive pinion (6.3) and the friction wheel (8) on the gear shaft (6.4) and from the friction wheel (8) onto the ring-shaped saw blade (1).

2. Handsaw with ring-shaped saw blade and a saw blade drive according to claim 1, wherein the flank toothings (7) formed into the inner circumferential face (1.2) of the ring-shaped saw blade (1) on two sides and the flank toothings (9) formed into the inner faces (8.2) of the friction wheel (8) by entering of recesses (7.1) into the inner circumferential face (1.2) of the ring-shaped saw blade (1) and of recesses (8.3) in the inner faces (8.2) of the front side groove (8.1) of the friction wheel (8).

3. Handsaw with ring-shaped saw blade according to claim 1, wherein the friction wheel (8) is formed out of two force matching and disengageable connected disks (8.4), which disks (8.4) form the groove (8.1) at their outer front face, wherein the oppositely disposed vertical inner faces (8.2) of the groove (8.1) are furnished with the flank toothing (9), wherein the flank toothing (9) forms a counter toothing to the flank toothing (7) of the ring-shaped saw blade (1).

4. Handsaw with ring-shaped saw blade and saw blade drive according to claim 1, wherein the guide rollers (4) exhibit at least three ring-shaped noses (4.1), which noses (4.1) engage into the at least three grooves (2) of the saw blade (1) and the support rollers (5) exhibit at least three grooves (5.1) and four press faces (5.2), which are laid-on oppositely to the guide rollers (4) with the press faces (5.2) at the planar side of the inner circumferential face (1.2) of the ring-shaped saw blade (1).

5. Handsaw with ring-shaped saw blade and a saw blade drive according to claim 2, wherein the flank toothings (7) and (9) are performed as an involute toothing or as a round toothing.

6. Handsaw with the ring-shaped saw blade and a saw blade drive according to claim 2, wherein the teeth of the flank toothings (7) formed into the inner circumferential face (1.2) of the ring-shaped saw blade (1) on two sides and the teeth of the flank toothings (9) formed into the inner faces (8.2) of the friction wheel (8) in each case are disposed opposite to each other at the same distance.

7. Handsaw with ring-shaped saw blade and a saw blade drive according to claim 2, wherein the teeth of the flank toothings (7) formed into the inner circumferential face (1.2) of the ring-shaped saw blade (1) on two sides and the teeth of the flank toothings (9) formed into the inner faces (8.2) of the friction wheel (8) are disposed in each case opposite to each other and staggered.

8. Handsaw with ring-shaped saw blade and a saw blade drive according to claim 3, wherein the friction wheel (8) is supported on the gear shaft (6.4) disposed parallel to the drive shaft (6.2) and wherein the friction wheel (8) is guided between the inner front face (1.3) of the ring-shaped saw blade (1) and a recess (10.1) in the outer circumference of the guide sheet metal ring (10).

9. Handsaw with ring-shaped saw blade and a saw blade drive according to claim 4, wherein the guide rollers (4) and the support rollers (5) are cylindrical hollow bodies, which are open at one front side and which exhibit at the oppositely disposed front side a broken out rest face (4.2) and (5.3) with a central bearing bore hole (4.3 and 5.4).

10. Circular saw with ring-shaped saw blade and a saw blade drive according to claim 4, wherein the guide rollers (4) and the support rollers (5) in each case are furnished with a tensioning mechanism, wherein the tensioning mechanism is supported in a radial direction at the housing (3) disposed on the front side around the ring-shaped saw blade (1) and by way of which the radial press-on pressure of the ring-shaped saw blade (1) can be regulated relative to and against the friction wheel (8).
